(19) United States
(12) Patent Application Publication
(10) Pub. No.: US 2025/0350950 A1
(43) Pub. Date: Nov. 13, 2025

(54) IDENTIFYING AND DISRUPTING CYBER-THREATS IN TELECOMMUNICATIONS NETWORKS

(71) Applicant: T-MOBILE INNOVATIONS LLC, Overland Park, KS (US)

(72) Inventors: Jeffrey Scott SIMON, Jr., Issaquah, WA (US); Geoffrey Todd GIBSON, Rowlett, TX (US); Derek Thomas OGLE, Everett, WA (US); James Cooper RICHARD, Blue Springs, MO (US)

(21) Appl. No.: 18/661,041

(22) Filed: May 10, 2024

(51) Int. Cl. H04W 12/122

(52) U.S. Cl. CPC H04W 12/122

(57) ABSTRACT

Aspects herein provide systems, devices, methods, and media for capturing, monitoring and thwarting malicious traffic within a telecommunication network. In aspects, a plurality of decoy nodes are deployed throughout the telecommunications network, wherein the decoy nodes provide realistic outputs and interfaces in response to input and user interactions. Interactions may be intelligently classified. Depending on the classifications, notifications may be communicated and/or action may be initiated the impeded malicious traffic and/or cyber threat actors in near real-time with the interactions.

### SUMMARY

A high-level overview of various aspects of the disclosure is provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

Aspects herein include a system, device, method, and media for identifying and disrupting cyber-threats within a telecommunications network.

### BRIEF DESCRIPTION OF THE DRAWINGS

Aspects are described in detail below with reference to the attached drawings figures, wherein:

FIG. 1 depicts an example of a system environment, in accordance with one or more aspects;

FIG. 2 depicts a flowchart of a method in accordance with one or more aspects; and

FIG. 3 depicts a simplified block diagram of an example device that is suitable for implementing one or more aspects discussed herein.

### DETAILED DESCRIPTION

The subject matter of the present disclosure is being described with specificity herein to meet statutory requirements. However, the description itself is not intended to limit the scope of this patent. Rather, the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present disclosure can be embodied in many different forms and should not be construed as limited to the embodiments and aspects set forth herein.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present disclosure. The following is a list of these acronyms:
3G Third-Generation Wireless Access Technology
4G Fourth-Generation Wireless Access Technology
5G/5G NR Fifth-Generation Wireless Access Technology/New Radio
5GC Fifth-Generation Wireless Access Technology Core Network
AAU Active Antenna Unit
BRS Broadband Radio Service
CD-ROM Compact Disk Read-Only Memory
CDMA Code Division Multiple Access
CU Central Unit
DU Distribution Unit
EIRP Equivalent Isotropically Radiated Power
eNodeB Evolved Node B
EVDO Evolution-Data Optimized
GIS Geographic/Geographical/Geospatial Information System
gNodeB/gNB Next Generation Node B
gNB CU Next Generation Node B Central Unit
gNB DU Next Generation Node B Distribution Unit
GPRS General Packet Radio Service
GSM Global System for Mobile Communication
iDEN Integrated Digital Enhanced Network
DVD Digital Versatile Disc
EEPROM Electrically Erasable Programmable Read-Only Memory
FD-MIMO Full Dimension Multiple-Input Multiple-Output
IoT Internet of Things
HOT Industry Internet of Things
IP Internet Protocol
LED Light Emitting Diode
LTE Long Term Evolution
MEC Mobile Far Edge Computer
MD Mobile Device
MIMO Multiple-Input Multiple-Output
mMIMO Massive Multiple-Input Multiple-Output
MMU Massive Multiple-Input Multiple-Output Unit
mmWave Millimeter Wave
NEXRAD Next-Generation Radar
NR New Radio
OOBE Out-of-Band-Emission
OTN Optical Transport Network
PC Personal Computer
PCS Personal Communications Service
PDA Personal Digital Assistant
PLMN Public Land Mobile Network
PRB Physical Resource Block
vPRB Virtualized Physical Resource Block
RAN Radio Access Network
RAM Random Access Memory
RET Remote Electrical Tilt
RF Radio-Frequency
RFI Radio-Frequency Interference
RIC Radio Intelligent Controller
RLF Radio Link Failure
R/N Relay Node
RNR Reverse Noise Rise
ROM Read-Only Memory
RRU Remote Radio Unit
RSRP Reference Signal Receive Power
RSRQ Reference Signal Receive Quality
RSSI Received Signal Strength Indicator
RU Radio Unit
SINR Signal-to-Interference-&-Noise Ratio
SNR Signal-to-Noise Ratio
SON Self-Organizing Networks
TDMA Time Division Multiple Access
TXRU Transceiver (or Transceiver Unit)
UE User Equipment
UMTS Universal Mobile Telecommunications System
UTRAN UMTS Radio Access Network
E-UTRAN Evolved Universal Mobile Telecommunications System
WCD Wireless Communication Device (interchangeable with UE)
WLAN Wireless Local Area Network
XR Extended Reality

Further, various technical terms are used throughout this description. An illustrative resource that fleshes out various aspects of these terms can be found in Newton's Telecom Dictionary, 25th Edition (2009).

Aspects herein may be embodied as, among other things: a method, system, or set of instructions embodied on one or more computer-readable media. Aspects may take the form of a hardware aspect or an aspect combining software and hardware. Some aspects may take the form of a computer program product that includes computer-useable or computer-executable instructions embodied on one or more computer-readable media.

### Definitions

“Computer-readable media” can be any available media and may include volatile and non-volatile media, as well as removable and non-removable media. By way of example, and not limitation, computer-readable media may include computer storage media and communication media. Computer-readable media may include both volatile and non-volatile media, removable and non-removable media, and may include media readable by a database, a switch, and various other network devices. Computer-readable media includes media implemented in any way for storing information. Examples of stored information include computer-useable instructions, data structures, program modules, and other data representations.

“Computer storage media” may include, without limitation, volatile and non-volatile media, as well as removable and non-removable media, implemented in any method or technology for the storage of information, such as computer-readable instructions, data structures, program modules, or other data. In this regard, computer storage media may include, but is not limited to, RAM, ROM, Electrically Erasable Programmable Read-Only Memory (EEPROM), flash memory or other memory technology, CD-ROM, DVD, holographic media, other optical disk storage, magnetic cassettes, magnetic tape, magnetic disk storage or other magnetic storage device, or any other medium that can be used to store the desired information and which may be accessed by the device 300 shown in FIG. 300. These technologies can store data momentarily, temporarily, or permanently.

“Communication media” may include, without limitation, computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner so as to encode information in the signal. By way of example, and not limitation, communication media includes wired media such as a wired network or direct-wired connection, and wireless media such as acoustic, radio frequency (RF), infrared, and other wireless media. Combinations of any of the above may also be included within the scope of computer-readable media.

The term “application” refers to software, a computer program, and/or an application programming interface that may be run by executing, by a processor, computer-readable instructions stored on memory for running the software. Examples of applications include social media applications, word processing applications, gaming application, messaging applications, video-streaming applications, and more, for example, as run on user devices.

“Network” refers to a network comprised of wireless and wired components that provide wireless communications service coverage, for example, to one or more user devices. For example, the network may include one or more, or a plurality of, wireless networks, hardwired networks, telecommunications networks, peer-to-peer networks, distributed networks, and/or any combination thereof. The network may comprise one or more access points, one or more cell sites (i.e., managed by an access point), one or more structures such as cell towers (i.e., having an antenna) associated with each access point and/or cell site, a gateway, a backhaul data center, a server that connects two or more access points, a database, a power supply, sensors, and other components not discussed herein, in various aspects. Examples of a network include a telecommunications network (e.g., 3G, 4G, 5G, CDMA, CDMA 1×A, GPRS, EVDO, TDMA, GSM, LTE, and/or LTE Advanced) and/or a satellite network (e.g., Low Earth Orbit [LEO], Medium Earth Orbit [MEO], or geostationary). Additional examples of a network include a wide area network (WAN), a local area network (LAN), a metropolitan area network (MAN), a wide area local network (WLAN), a personal area network (PAN), a campus-wide network (CAN), a storage area network (SAN), a virtual private network (VPN), an enterprise private network (EPN), a home area network (HAN), a Wi-Fi network, a Worldwide Interoperability for Microwave Access (WiMAX) network, and/or an ad hoc (mesh) network. The network may include or may communicate with a physical location component for determining a geographic location of an item, package, parcel, personnel, vehicle, end-point location, etc., by leveraging, for example, a Global Positioning System (GPS), Global'naya Navigatsionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity [SOP]).

“Access point” and “base station” are used interchangeably herein to reference hardware, software, devices, or other components for a communications device or structure having an antenna, an antenna array, a radio, a transceiver, and/or a controller. An access point can be deployed terrestrially at or near the Earth's surface, or within the atmosphere, for example, to orbit the Earth. For example, an “aerospace access point” may be a satellite deployed to orbit the Earth within or above the atmosphere (e.g., in the thermosphere or exosphere), whereas a “terrestrial access point” may be a fixed or semi-fixed base station located on the Earth's surface or upon any structure located on the surface. As discussed herein, an access point is a device comprised of hardware and complex software that is deployed in a network so that the access point can control and facilitate, via one or more antennas or antenna arrays, the broadcast, transmission, synchronization, and receipt of wireless signals in order to communicate with, verify, authenticate, and provide wireless communications service coverage to one or more user devices that request to join and/or are connected to the network. Generally, an access point can communicate directly with one or more user devices according to one or more access technologies (e.g., 3G, 4G, LTE, 5G, and mMIMO). An example of an aerospace access point includes a satellite. Examples of a terrestrial access point include a base station, an eNodeB, a gNodeB, a macrocell, a small cell, a microcell, a femtocell, a picocell, and/or a computing device capable of acting as a wireless “hotspot” that enables connectivity to the network. Accordingly, the scale and coverage area of various types of access points are not limited to the examples discussed. Access points may work alone or in concert with one another, locally or remotely.

“Cell site” is generally used herein to refer to a defined wireless communications coverage area (i.e., a geographic area) serviced by an access point or a plurality of neighboring access points working together to provide a single coverage area. Also, it will be understood that one access point may control one cell site/coverage area, or, alternatively, one access point may control multiple cell sites/coverage areas.

“User equipment” (UE), “user device,” “mobile device,” and “wireless communication device” are used interchangeably to refer to a device having hardware and software that is employed by a user in order to send and/or receive electronic signals/communication over one or more networks, whether terrestrial or aerospace. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

The terms “radio,” “controller,” “antenna,” and “antenna array” are used interchangeably herein to refer to one or more software and hardware components that facilitate sending and receiving wireless radio frequency signals, for example, based on instructions from a base station. A radio may be used to initiate and generate information that is then sent out through the antenna array, for example, where the radio and antenna array may be connected by one or more physical paths. Generally, an antenna array comprises a plurality of individual antenna elements. The antennas discussed herein may be dipole antennas having a length, for example, of ¼, ½, 1, or 1½ wavelengths. The antennas may be monopole, loop, parabolic, traveling-wave, aperture, Yagi-Uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that sequential or relative terms such as “first,” “second,” “third,” “primary,” and/or “secondary” are used herein for the purposes of clarity in distinguishing between elements or features, but the terms are not used herein to import, imply, or otherwise limit the relevance, importance, quantity, technological functions, physical or temporal sequence, physical or temporal order, and/or operations of any element or feature unless specifically and explicitly stated as such.

### Overview

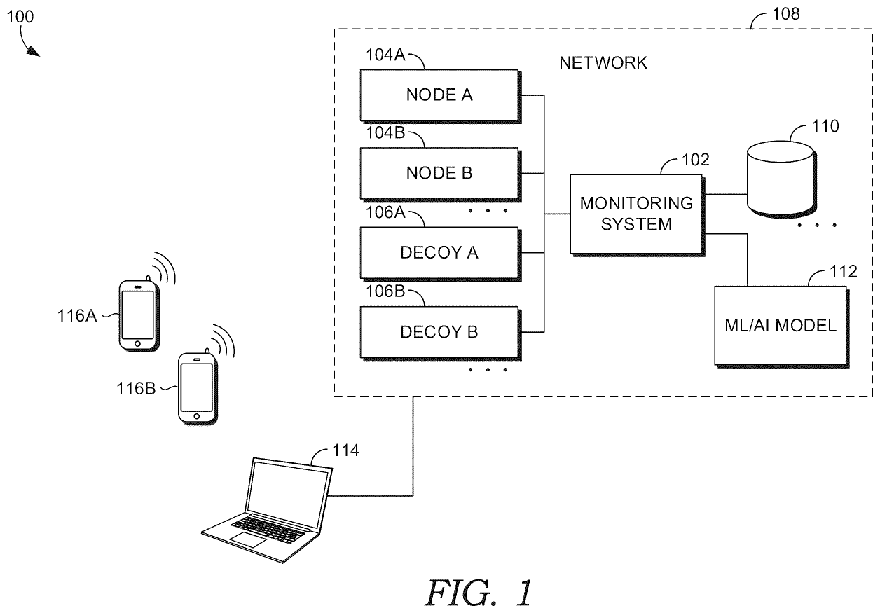

Beginning with FIG. 1, it depicts an example of a system environment 100. The system environment 100 includes a monitoring system 102. The monitoring system 102 is integrated within a network 108, and further, may be centralized (e.g., within a core portion or backhaul of the network 108). The monitoring system 102 may include one or more applications running on a particular or specially configured server, for example, a Splunk® server and/or a Unified Computing System (UCS), such as a Cisco® server. The server may be configured for operations involving data analytics, log management, monitoring and observation, and more, in various examples. In an example, monitoring system 102 operates or runs on a server that is specially configured to extract structure and analyze machine-generated data.

The system environment 100 further includes a plurality of nodes 104A and 104B that are functional and operational within a network 108, and a plurality of decoy nodes 106A and 106B that are deployed within the telecommunications network 108. Examples of the plurality of nodes 104A and 104B include a 5G user plane function (UPF) node, a Unified Data Repository (UDR) node, a Unified Data Management (UDM) node, a Secure Shell Daemon application (SSH daemon) node, and an Authentication Server Function (AUSF) node. Each decoy node is generated to mimic an actual node and/or a specific type of node within the telecommunications network. For example, a decoy node may be generated to mimic the interfaces and/or operations of a 5G user plane function (UPF) node, while another decoy node may be generated to mimic the interfaces and/or operations of a Unified Data Repository (UDR) node. Thus, the plurality of decoy nodes 106A and 106B may be distinct from one another, as each is able to mimic various particular types of actual nodes, or even to mimic specific individual nodes within the network 108.

The decoy nodes are configured to appear as realistic by visibly and/or outwardly replicating the functions and/or interfaces of actual nodes, for example, when the decoy node is electronically examined or interacted with. Accordingly, the decoy nodes may mimic a 5G user plane function (UPF) node, a Unified Data Repository (UDR) node, a Unified Data Management (UDM) node, a Secure Shell Daemon application (SSH daemon) node, an Authentication Server Function (AUSF) node, or any combination thereof. In aspects, when a human entity or a “bot” electronically interact with a decoy node and corresponding interface via inputs (e.g., typing a login, entering a command, clicking a button), the decoy node functions to generated and provide outputs (e.g., in an interface, a pop-up, text, images, or the like) for presentation at the device of the human entity or bot that are the same or similar outputs as would be provided by an actual node of that type or identity. These outputs lack sensitive data and are devoid of sensitive information. In other words, the outputs include false or fake data that mimics the data and information that an actual node of that type or identity would be expected or predicted to provide, thereby deceiving the human entity or bot that the decoy node is an actual node in full operation within the network 108. Further, in some aspects, the decoy node may be generated to include an imitation of a cybersecurity vulnerability, in addition to mimicking an actual node or node type. The imitation vulnerability may be electronically visible or detectable (to some degree) so as to attract a human entity or a bot that might seek to exploit such a vulnerability on an actual or “true” node, in order to prompt their interaction with the decoy node and corresponding false interface(s). As used herein, a cybersecurity vulnerability refers to defect, loophole, or weakness in the system that allows outside and/or unauthorized entities, whom may be curious or malicious, to access that node, its functions, and/or capture its traffic. The cybersecurity vulnerability may be specific to 3GPP nodes or the like.

The monitoring system 102 monitors one or more of the plurality of decoy nodes 106A and 106B, for example, to detect one or more interactions with said decoy node(s). In some aspects, the monitoring system 102 may also monitor one or more of the plurality of nodes 104A and 104B that are functional and operational within a telecommunications network 108. In various aspects, the monitoring system 102 detects, captures, and records each interaction that occurs for each decoy node. In other words, the monitoring system 102 captures each interaction (e.g., input, click, or navigation), each output, each interface, as well as data or information that is associated with a corresponding interaction, output, or interface, the device associated with those, and more.

Examples include a timestamp for each input and/or output, a quantity of keystrokes input for each interface and/or for particular interface(s), the actual input that is provided (e.g., identifying of a particular command that is entered/typed) to the decoy node, the output provided by the decoy node, a total quantity of keystrokes of the input, a total duration of the visit with the node (e.g., view time of the human entity or bot), a quantity of interfaces viewed or interacted with per session, a bounce rate or time (e.g., human entity or bot visits the node but leaves without further interaction), a duration of time spent with each interface (e.g., actual or average time on an interface) and/or particular interface(s), a total or average duration of time that lapses between each input/interaction, a total duration of all the interactions with the node, an Internet Protocol (IP) address associated with the input or device providing the input, a type of the device providing the input, an electronic address of the decoy node, a unique identified of the decoy node, the type of node the decoy node mimics, whether the decoy includes one or more particular imitation vulnerabilities, whether the human entity or bot interacted in a manner that engaged one or more of the particular imitation vulnerabilities, and more.

The monitoring system 102 may provide the interactions, data, and information obtained by monitoring the decoy nodes as input to be ingested and used to train a machine learning model 112. As such, each decoy node may be subsequently monitored and the machine learning model 112 may be leveraged by the monitoring system 102 to identify malicious attacks within the network 108.

The system environment 100 includes a repository 110 that the monitoring system 102 can utilize by sending interaction data for storage and/or receiving various data, for example, in training the machine learning model 112 and/or for determining patterns when monitoring decoy nodes, as further discussed hereinafter. In some aspects, the repository 110 is centralized (e.g., within a core portion or backhaul of the network 108).

Having described the system environment 100 and components thereof, it will be understood by those of ordinary skill in the art that system environment 100 is but one example of a suitable environment and is not intended to limit the scope of use or functionality of the present invention. Similarly, system environment 100 should not be interpreted as imputing any dependency and/or any requirements with regard to each component and combination(s) of components illustrated in FIG. 1. It will be appreciated by those of ordinary skill in the art that the location of components illustrated in FIG. 1 is an example, as other methods, hardware, software, components, and devices for establishing a communication links between the components shown in FIG. 1, may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should be not be interpreted as limiting the present invention to exclude additional components and combination(s) of components. Moreover, though components are represented in FIG. 1 as singular components, it will be appreciated that some embodiments may include a plurality of devices and/or components such that FIG. 1 should not be considered as limiting the number of a device or component.

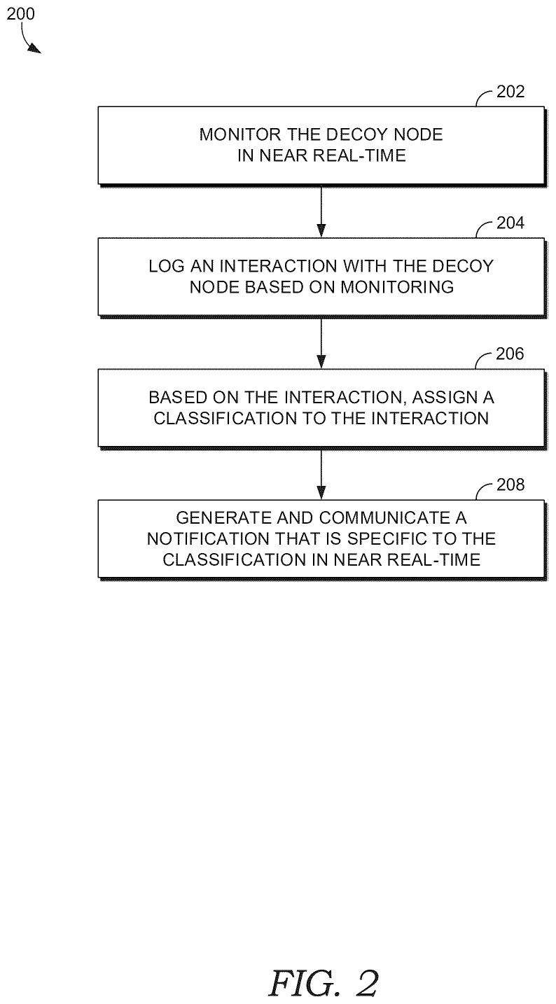

Turning to FIG. 2, a flowchart of a method 200 is provided. In various aspects, the method 300 can be a computer-implemented method, for example, by one or more components such as those within the network 108 shown in FIG. 1. In some aspects, one or more non-transitory computer-readable storage media having computer-readable instructions or computer-readable program code portions embodied thereon, for execution via one or more processors, can be used to implement and/or perform the method 200. For example, computer-readable instructions or computer-readable program code portions can specify the performance of the method 200, can specify a sequence of steps of the method 200, and/or can identify particular component(s) of software and/or hardware for performing one or more of the steps of the method 200, in aspects. The computer-readable instructions or computer-readable program code portions can correspond to an application and/or an application programming interface (API), in some embodiments. In one embodiment, the application or API can implement and/or perform the method aspects. As discussed below, the method 300 can be performed using software, hardware, component(s), and/or device(s) depicted in the example of FIG. 1. In aspects, the method 200 may be performed by the monitoring system 102 of FIG. 1.

At block 202, a decoy node in monitored in near real-time. The monitoring system 102 of FIG. 1 may monitor one or more decoy nodes in a network, as presently discussed above. At block 204, an interaction with the decoy node is logged, based on the monitoring of said node. The monitoring system 102 of FIG. 1, for example, may detect, identify, record, and/or capture one or more interactions with individual decoy nodes in a network, as mentioned previously. In some aspects, the monitoring system 102 of FIG. 1 may apply functions to remove noise from the interaction(s), for example, using a machine learning model that is trained using historical or simulated interactions.

In some instances, a plurality of interactions with the decoy node are logged, based on the monitoring of said node. In one example, the monitoring system 102 may identify a pattern in the plurality of interactions using a machine learning model that is trained using historical or simulated interactions. The pattern may be indicative of an intelligent malicious entity or a malicious bot in various aspects.

For example, the monitoring system 102 may identify a pattern in the plurality of interactions using the trained machine learning model. The pattern may be indicative of a malicious bot wherein there is a pattern of “rapid fire” interactions with the decoy node. For example, there may be extremely short lapses of time (e.g., one second, or milliseconds) between inputs and interactions with the decoy node in combination with a very short total duration of the visit with the node, as well as a high quantity of interfaces that are viewed or interacted with in that very short visit. Such a pattern may be indicative of a bot interacting with a node, and seeking to locate and exploit a vulnerability.

In another example, the monitoring system 102 may identify a different pattern in the plurality of interactions using the trained machine learning model. The pattern may be indicative of a malicious user (human entity) that differs from the “rapid fire” interactions of a bot. For example, there may be interactions that include specific and advanced commands being entered into the decoy node. Additionally or alternatively, there may be interactions having a longer duration of visit to the node (e.g., no or low “bounce time”). Such pattern(s) may be indicative of a malicious user interacting with a node, and seeking to locate and exploit a vulnerability.

In various aspects, patterns might be recognized by the monitoring system 102, without human intervention, based on the IP address associated with the input or device providing the input, in combination with the type of the device providing the input, and the type of node the decoy node mimics, for example. In various examples, the patterns made be based on one or more of: a quantity of interfaces viewed or interacted with per session, a bounce rate or time, a duration of time spent with each interface and/or particular interface(s), a total or average duration of time that lapses between each input/interaction, a total duration of all the interactions with the node, an IP address associated with the input or device providing the input, a type of the device providing the input, an electronic address of the decoy node, a unique identified of the decoy node, the type of node the decoy node mimics, whether the decoy includes one or more particular imitation vulnerabilities, whether the human entity or bot interacted in a manner that engaged one or more of the particular imitation vulnerabilities, or any combination thereof.

Continuing with the method 200 at block 206, a classification is assigned to the interaction based on the interaction. In aspects, the classification that is assigned is specific to the pattern identified by the monitoring system 102. The classification may specify, identify, and/or corresponds to an entity type, for example: a bot entity type, an intermediate user, an advanced user. Additionally or alternatively, the classification may specify, identify, and/or corresponds to a risk, threat, or notification level, for example: a low level, an intermediate level, a high level, and/or an extreme level.

In response to assigning the classification to the interaction, one or more actions may be initiated and performed by components within the network, such as a telecommunications network. For example, a service in the network for a user account, a user device, or a combination thereof, that is associated with the interaction classified may be revoked, interrupted or frozen. Examples of services include data services, voice services, roaming services, streaming services, location services, and/or any combination thereof. In some aspects, one or more services are modified (e.g., impeded, slowed, revoked, interrupted, specific functions suspended, and/or frozen) as being specific and responsive to the classification (e.g., entity type, level, or combination thereof), wherein the modification to the service(s) disrupts the malicious entity or bot's interactions and/or prevent the malicious entity or bot from further interactions in the network. In one example, in response to assigning the classification to the interaction, revoking a service in the telecommunications network for a user device is associated with the interaction, wherein the service that is revoked is specific to the classification, and wherein the service comprises: data services, voice services, roaming services, streaming services, location services, or any combination thereof.

At block 208, a notification is generated and communicated in near real-time, where that notification is specific to the classification. The notification may comprise or be a message, an alert, a computer-readable instruction, and/or an alarm, in various aspects. The notification may be communicated in the network to one or more nodes, user devices, servers, gateways, databases, applications, the cloud, or any combination therefor, in order to trigger, initiate or cause remediation actions. In some aspects, a plurality of notifications may be generated and communicated to various destinations, devices, users, nodes, and/or other components. In various aspects, the notification specifies that the plurality of interactions are predicted to be associated with the intelligent malicious entity. In another aspect, the notification specifies that the plurality of interactions are predicted to be associated with the malicious bot.

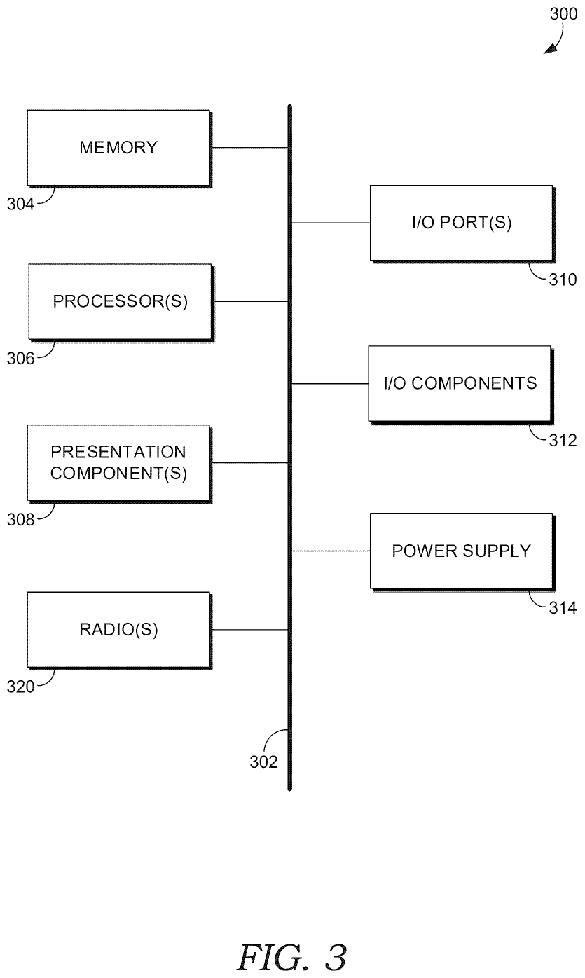

FIG. 3 depicts a simplified block diagram of an example device 300 that is suitable for implementing one or more aspects discussed herein. The device 300 is but one example of a suitable computing environment and is not intended to suggest any limitation as to the scope of use or functionality of the disclosure, and nor should the device 300 be interpreted as having any dependency or requirement relating to any one or combination of components illustrated.

The implementations of the present disclosure may be described in the general context of computer code or machine-useable instructions, including computer-executable instructions such as program components being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 3, the device 300 includes bus 302 that directly or indirectly couples with the following devices: memory 304, one or more processors 306, one or more presentation components 308, input/output (I/O) ports 310, I/O components 312, and power supply 314. Bus 302 represents what may be one or more buses (such as an address bus, data bus, or combination thereof). Although the devices of FIG. 3 are shown with lines for the sake of clarity, in reality, delineating various components is not so clear, and metaphorically, the lines would more accurately be grey and fuzzy. For example, one may consider a presentation component such as a display device to be one of I/O components 312. Also, processors, such as one or more processors 306, have memory. Distinction is not made between such categories as “workstation,” “server,” “laptop,” “handheld device,” etc., as all are contemplated within the scope of FIG. 3 and refer to “computer” or “computing device.”

The device 300 typically includes a variety of computer-readable media. Computer-readable media can be any available media that can be accessed by the device 300 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, digital versatile disks (DVDs) or other optical disk storage, magnetic cassettes, magnetic tape, and magnetic disk storage or other magnetic storage devices. Computer storage media does not comprise a propagated data signal.

Communication media typically embodies computer-readable instructions, data structures, program modules or other data in a modulated data signal (such as a carrier wave or other transport mechanism), and includes any information delivery media. The term “modulated data signal” indicates a signal that has one or more of its characteristics set or changed in such a manner so as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 304 includes computer storage media in the form of volatile and/or non-volatile memory. Memory 304 may be removable, non-removable, or a combination thereof. Examples of memory include solid-state memory, hard drives, optical disc drives, etc. The device 300 includes one or more processors 306, which read data from various entities such as bus 302, memory 304, or I/O components 312. One or more presentation components 308 present data indications to a person or other device. Examples of one or more presentation components 308 include a display device, speaker, printing component, vibrating component, etc. The I/O ports 310 allow the device 300 to be logically coupled to other devices including I/O components 312, some of which may be built into the device 300. The example I/O components 312 include a microphone, joystick, game pad, satellite dish, scanner, printer, wireless device, etc.

Radio 316 represents a radio that facilitates communication with a wireless telecommunications network. Illustrative wireless telecommunications technologies include CDMA, GPRS, TDMA, GSM, and the like. Radio 316 might additionally or alternatively facilitate other types of wireless communications including Wi-Fi, WiMAX, LTE, or other VoIP communications. As can be appreciated, in various aspects the radio 316 can be configured to support multiple technologies, and/or multiple radios can be utilized to support multiple technologies. A wireless telecommunications network might include an array of devices, which are not shown so as to not obscure more relevant aspects of the disclosure. Components such as a base station, a communications tower, or even access points (as well as other components) can provide wireless connectivity in some aspects.

Regarding FIGS. 1 through 3, it will be understood by those of ordinary skill in the art that the environment(s), system(s), and/or methods(s) depicted are not intended to limit the scope of use or functionality of the present aspects. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated in the figures are contemplated to potentially include methods, hardware, software, and/or other devices for establishing a communications link between the components, devices, systems, and/or entities, as may be utilized in implementation of the present aspects. As such, the absence of component(s) and/or steps(s) from the figures should not be interpreted as limiting the present aspects to exclude additional component(s) and/or combination(s) of components. Moreover, though devices and components in the figures may be represented as singular devices and/or components, it will be appreciated that some aspects can include a plurality of devices and/or components such that the figures should not be considered as limiting the number of a devices and/or components.

Many different arrangements of the various components depicted, as well as components not shown, are possible without departing from the scope of the claims below. Aspects of our technology have been described with the intent of being illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A computerized method comprising:
generating a decoy node that mimics a particular node in a telecommunications network;
monitoring the decoy node in near real-time;
logging an interaction with the decoy node based on monitoring;
based on the interaction, assigning a classification to the interaction; and
generating and communicating a notification that is specific to the classification in near real-time.

2. The method of claim 1, wherein the decoy node mimics:
a 5G user plane function (UPF) node;
a Unified Data Repository (UDR) node;
a Unified Data Management (UDM) node;
a Secure Shell Daemon application (SSH daemon) node;
an Authentication Server Function (AUSF) node; or
any combination thereof.

3. The method of claim 1, wherein the decoy node includes an imitation of a cybersecurity vulnerability.

4. The method of claim 1, further comprising, in response to assigning the classification to the interaction, revoking a service in the telecommunications network for a user account that is associated with the interaction, wherein the service that is revoked is specific to the classification, and wherein the service comprises: data services, voice services, roaming services, streaming services, location services, or any combination thereof.

5. The method of claim 1, further comprising, in response to assigning the classification to the interaction, revoking a service in the telecommunications network for a user device is associated with the interaction, wherein the service that is revoked is specific to the classification, and wherein the service comprises: data services, voice services, roaming services, streaming services, location services, or any combination thereof.

6. The method of claim 1, wherein the interaction comprises a plurality of interactions, the method further comprising:
identifying a pattern in the plurality of interactions, wherein the classification that is assigned is specific to the pattern identified.

7. The method of claim 6, wherein the pattern identified is indicative of an intelligent malicious entity, and wherein the notification specifies that the plurality of interactions are predicted to be associated with the intelligent malicious entity.

8. The method of claim 6, wherein the pattern identified is indicative of a malicious bot, and wherein and wherein the notification specifies that the plurality of interactions are predicted to be associated with the malicious bot.

9. The method of claim 1, wherein the interaction comprises a plurality of interactions, the method further comprising removing noise from the plurality of interactions using a machine learning model.

10. One or more non-transitory computer-readable media storing instructions that when executed via one or more processors perform a computerized method, the instructions stored on the one or more non-transitory computer-readable media comprising:
generating a decoy node that mimics a particular node in a telecommunications network;
monitoring the decoy node in near real-time;
logging an interaction with the decoy node based on monitoring;
based on the interaction, assigning a classification to the interaction; and
generating and communicating a notification that is specific to the classification in near real-time.

11. The media of claim 10, wherein the decoy node mimics:
a 5G user plane function (UPF) node in a core portion of the telecommunications network;
a Unified Data Repository (UDR) node;
a Unified Data Management (UDM) node;
a Secure Shell Daemon application (SSH daemon) node; or
an Authentication Server Function (AUSF) node.

12. The media of claim 10, wherein the decoy node wherein the decoy node includes an imitation of a cybersecurity vulnerability.

13. The media of claim 10, the instructions further comprising, in response to assigning the classification to the interaction, revoking a service in the telecommunications network for a user account that is associated with the interaction, wherein the service that is revoked is specific to the classification, and wherein the service comprises: data services, voice services, roaming services, streaming services, location services, or any combination thereof.

14. The media of claim 10, the instructions further comprising, in response to assigning the classification to the interaction, revoking a service in the telecommunications network for a user device is associated with the interaction, wherein the service that is revoked is specific to the classification, and wherein the service comprises: data services, voice services, roaming services, streaming services, location services, or any combination thereof.

15. The media of claim 10, wherein the interaction comprises a plurality of interactions, the instructions further comprising:
identifying a pattern in the plurality of interactions, wherein the classification that is assigned is specific to the pattern identified.

16. The media of claim 15, wherein the pattern identified is indicative of an intelligent malicious entity, and wherein the notification specifies that the plurality of interactions are predicted to be associated with the intelligent malicious entity.

17. The media of claim 15, wherein the pattern identified is indicative of a malicious bot, and wherein and wherein the notification specifies that the plurality of interactions are predicted to be associated with the malicious bot.

18. The media of claim 10, wherein the interaction comprises a plurality of interactions, the instructions further comprising removing noise from the plurality of interactions using a machine learning model.

19. The media of claim 15, wherein the decoy node comprises a plurality of decoy nodes that are replications of a plurality of particular nodes in the telecommunications network, the instructions further comprising:
training a machine learning model using interactions monitored for each decoy node; and
subsequently monitoring each decoy node using the machine learning model to identify malicious attacks within the telecommunications network.

20. A system comprising:
a plurality of decoy nodes deployed in a telecommunications network, each decoy node in the plurality mimicking an actual node with an imitation of a cybersecurity vulnerability;
a centralized monitoring system deployed in the telecommunications network;
a centralized repository associated with the centralized monitoring system deployed in the telecommunications network to store data that is associated with an interaction in near real-time;
wherein the centralized monitoring system is configured to:
monitor a plurality of decoy nodes in near real-time via the centralized monitoring system;
log the interaction with at least one of the plurality of decoy nodes based on monitoring;
based on the interaction, assign a classification to the interaction; and
generate and communicate a notification that is specific to the classification in near real-time.
